(19) United States
(12) Patent Application Publication
(10) Pub. No.: US 2006/0260200 A1
(43) Pub. Date: Nov. 23, 2006

(54) Window holder for a window regulator

(76) Inventor: Jean-Francois Bigourden, Neudorf-Platendorf (DE)

Correspondence Address: CARLSON, GASKEY & OLDS, P.C., 400 WEST MAPLE ROAD, SUITE 350, BIRMINGHAM, MI, 48009, US

(21) Appl. No.: 11/412,718

(22) Filed: Apr. 27, 2006

(30) Foreign Application Priority Data
Apr. 29, 2005 (DE) 10 2005 020 052.4

(51) Int. Cl. E05F 11/38

(52) U.S. Cl. 49/374; 49/348

(57) ABSTRACT

A window holder for a window regulator includes a base member, a clamping member that cooperates with the base member, and a clamping rubber located between the base member and the clamping member. A gap is defined inside the clamping rubber. A window pane can be inserted into this gap. The clamping rubber, and/or the base member together with the clamping member, are configured such that a wedge effect is provided when the window pane is loaded relative to the window holder in a direction of extraction.

### RELATED APPLICATIONS

The application claims priority to German Application No. 10 2005 020 052.4, which was filed on Apr. 29, 2005.

### TECHNICAL FIELD

This invention relates to a window holder for a window regulator.

### BACKGROUND OF THE INVENTION

A window regulator can be used for shifting a window pane, e.g. the window pane of a vehicle door, between a closed position and an open position. Typically, the window regulator includes a guideway that is mounted in a vehicle door, for example, and extends in a generally vertical direction. A carriage is disposed on the guideway and can be moved along the guideway. At the carriage, a window holder is mounted, into which a lower edge of the window pane is clamped. When the carriage is moved along the guideway, e.g. with an electric motor and a drive cable, the carriage moves the window pane via the window holder.

The connection between the window pane and the window holder of the window regulator must be able to withstand an extraction force specified by the vehicle manufacturer in order to prevent the window pane from undesirably separating from the window holder. Separation might occur when the forces necessary for moving the window pane are higher than the extraction force. For instance, this could occur when the window pane is opened, after the window pane has been closed for an extended period, particularly at cold temperatures. In this situation, a rubber seal extending around an edge of the window aperture has typically contracted and has tightly enclosed the edge of the window pane. Separation could also occur with a partly open window pane. If a vehicle occupant seizes an exposed upper edge of the window pane and pulls the window pane in the direction of the closed position, separation could occur because known window holders cannot always withstand such high extraction forces.

It is the object of the invention to provide a window holder that provides for particularly high extraction forces between the window holder and the window pane.

### SUMMARY OF THE INVENTION

For this purpose, the invention provides a window holder for a window regulator that includes a base member, a clamping member that cooperates with the base member, and a clamping rubber located between the base member and the clamping member. A gap is defined inside the clamping rubber into which a window pane can be inserted. The clamping rubber, and/or the base member together with the clamping member, are configured such that a wedge effect is obtained when the window pane is loaded relative to the window holder in a direction of extraction. Due to the wedge effect, the holding forces automatically increase. When the window pane is loaded in the direction of extraction, the clamping rubber is shifted by a very small, barely visible, distance. Due to friction between the window pane and the clamping rubber, the clamping rubber is carried along with the window pane. Due to the wedge effect, the minor displacement of the clamping rubber is translated into an increasing clamping force, which is exerted by the base member and the clamping member onto the window pane in a direction vertical to a plane defined by the window pane. This higher clamping force will in turn lead to a higher extraction force.

The wedge effect can be obtained because in a region between the window pane and the base member or the clamping member, the clamping rubber has a wall thickness that is decreasing in a direction away from a bottom of the gap. Alternatively or in addition, the base member and the clamping member are configured such that their distance in the vicinity of the gap is decreasing in a direction away from the bottom of the gap. These configurations result in the clamping rubber being compressed to a greater extent when the clamping rubber is loaded in the direction of extraction of the window pane.

The base member and/or the clamping member can be provided with a barb that engages a projection of a seal, so that the seal is reliably retained at the base member.

These and other features of the present invention can be best understood from the following specification and drawings, the following of which is a brief description.

### BRIEF DESCRIPTION OF THE DRAWINGS

FIG. 1 shows a side view of a window holder in accordance with the prior art.

FIG. 2 shows a side view of a window holder of the invention.

### DETAILED DESCRIPTION OF THE PREFERRED EMBODIMENT

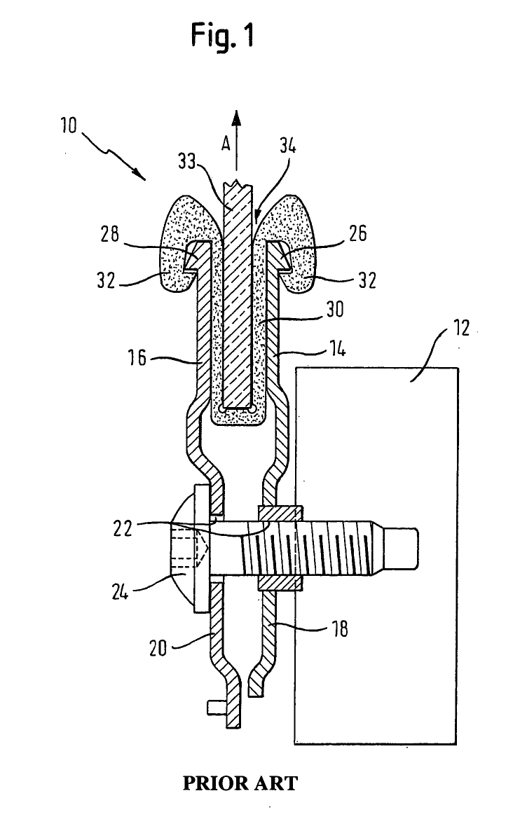

FIG. 1 shows a window holder 10 for a window regulator that forms part of a known window regulator used in vehicles. The window regulator is mounted on a vehicle body.

The window regulator includes a carriage 12 that is movably mounted on a guide rail (not shown). The window holder 10 includes a base member 14 and a clamping member 16, which both are bent parts punched out of sheet metal. The base and clamping members 14, 16 both have a fastening portion 18, 20 with a bore 22. The bores 22 serve to accommodate a clamping screw 24 that extends through the clamping member 16 and the base member 14, and which can attach the clamping member 16 and base member 14 to the carriage 12. When the clamping screw 24 is tightened, the clamping member 16 is urged against the base member 14.

At an upper edge with respect to the Figures, the base and clamping members 14, 16 are each provided with a barb 26, 28, which constitutes an embossed portion. The barb 26 of the base member 14 is facing the carriage 12, and the barb 28 of the clamping member 16 is facing away from the carriage 12. The barbs 26, 28 are formed across the entire width of the base and clamping members 14, 16.

There is provided a clamping rubber 30 that is mounted between the base member 14 and the clamping member 16, and which has a U-shaped cross-section. The term “clamping rubber” is used here as a generic term for a component that is used as an interlayer of limited elasticity between the base member 14 and the clamping member 16 on the one hand, and a window pane 33 on the other hand. The purpose of the clamping rubber 30 on the one hand is to prevent a direct contact between the base 14 and clamping 16 members, which are made of metal, and the window pane 33; otherwise, a direct contact might lead to a local overload of the window pane 33 and to the destruction thereof. On the other hand, the clamping rubber 30 should have a high friction both with the base 14 and clamping 16 members and with the window pane 33, to permit transmission of a high extraction force between the window holder 10 and the window pane 33. Thermoplastic elastomer (TPE) or a gum type material can be used for the clamping rubber 30.

The clamping rubber 30 has two lip-shaped projections 32, which cooperate with the barbs 26, 28 of the base and clamping members 14, 16, so that the clamping rubber 30 is reliably retained at the base member 14 and at the clamping member 16. Between the base member 14 and the clamping member 16, the clamping rubber 30 has two side walls and a bottom. The window pane 33 is inserted into a gap 34 defined by the side walls and the bottom. As shown in FIG. 1, the two side walls of the clamping rubber 30 are configured with a constant wall thickness, and in the vicinity of the clamping rubber 30, the base member 14 and the clamping member 16 extend parallel to each other.

After the window pane 33 has been inserted into the gap 34, the clamping screw 24 is tightened. As a result, the window pane 33 is clamped between the base member 14 and the clamping member 16. A maximum transferable extraction force is determined by the clamping force acting vertical to a plane defined by the window pane 33, multiplied by a coefficient of friction between the window pane 33 and the clamping rubber 30.

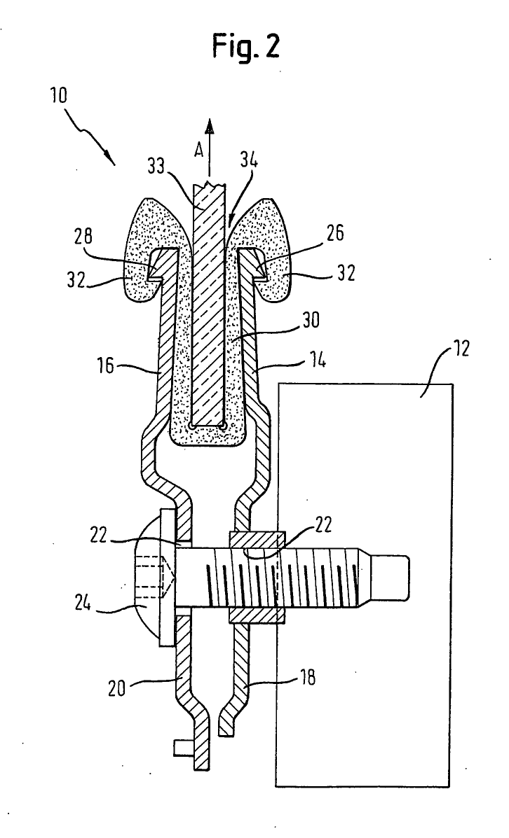

In FIG. 2, a window holder 10 in accordance with the invention is illustrated. For the various components the same reference numerals are used as in FIG. 1, and subsequently only the differences will be described.

The two side walls of the clamping rubber 30 have a wall thickness that is decreasing from the bottom towards an entrance to the gap 34. In addition, the base member 14 and the clamping member 16 are configured such that their distance from each other in the vicinity of the clamping rubber 30 is decreasing from the bottom towards the entrance to the gap 34.

When the window pane 33 is subjected to a load in a direction of extraction A, the clamping rubber 30 is slightly shifted towards the entrance of the gap 34, i.e. in the direction of extraction A. Since the wall thickness of the side walls is increasing against the direction of extraction A, and the distance between the base member 14 and the clamping member 16 is decreasing in the direction of extraction A, the clamping rubber 30 will get “wedged” between the base member 14 and the clamping member 16, as the clamping rubber 30 is shifted. As a result, the clamping force acting vertical to the plane of the window pane 33 is increased, and hence the extraction force is increased that is necessary to withdraw the window pane 33 from the clamping rubber 30.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A window holder for a window regulator comprising:
a base member;
a clamping member that cooperates with the base member; and
a clamping rubber located between the base member and the clamping member, wherein a gap is defined inside the clamping rubber into which a window pane can be inserted, and wherein at least one of the clamping rubber and the base member together with the clamping member are configured to provide a wedge effect when the window pane is loaded relative to the window holder in a direction of extraction.

2. The window holder as claimed in claim 1, wherein in a region between at least one of the window pane and the base member and the window pane and the clamping member, the clamping rubber has a wall thickness that is decreasing in a direction away from a bottom of the gap.

3. The window holder as claimed in claim 1 wherein the base member and the clamping member are configured such that a distance in a region of the gap is decreasing in a direction away from the bottom of the gap.

4. The window holder as claimed in claim 3 wherein, in a vicinity of the gap, the base member and the clamping member extend at an angle relative to a central plane of the gap.

5. The window holder as claimed in claim 1 wherein the clamping rubber is made of gum.

6. The window holder as claimed in claim 1 wherein the clamping rubber is made of a thermoplastic elastomer.

7. The window holder as claimed in claim 1 wherein at least one of the base member and the clamping member are provided with a barb that engages a projection of the clamping rubber.

8. The window holder as claimed in claim 1 wherein the clamping rubber includes two side walls and a bottom wall, and wherein each side wall has a portion having a thickness that is less than a thickness of the bottom wall.

9. The window holder as claimed in claim 8 wherein the thickness of each side wall decreases in a direction extending away from the bottom wall.
